(19) United States
(12) Patent Application Publication
(10) Pub. No.: US 2002/0107891 A1
(43) Pub. Date: Aug. 8, 2002

(54) Device-independent content acquisition and presentation

(76) Inventors: Andrew P. Leamon, Wayne, PA (US); Andrew W. Monroe, Philadelphia, PA (US); Matthew C. Poole, Philadelphia, PA (US); John Lommock, Hatboro, PA (US)

Correspondence Address: Daniel H. Golub, 1701 Market Street, Philadelphia, PA, 19103, US

(21) Appl. No.: 10/068,236

(22) Filed: Feb. 6, 2002

Related U.S. Application Data
(60) Provisional application No. 60/266,969, filed on Feb. 6, 2001.

(51) Int. Cl. G06F 15/00

(52) U.S. Cl. 707/513

(57) ABSTRACT

A system and method for formatting content for display on a device is disclosed. One or more data sources of information objects comprising at least one computer language object, at least one browser object, and at least one device object are maintained. A request for information is received from a device over a global communications network. A device type is identified, the device type comprising a communication format, a browser type, and a hardware type. The content is retrieved in response to the request and is formatted in a standard markup language regardless of the identified device type. One of the computer language objects for the identified communication format, one of the browser objects for the identified browser type, and one of the device objects for the identified hardware type are retrieved from at least one of the data sources. Based on the retrieved computer language object, browser object and device object, the content is reformatted into a language that enables display of the content on the device. The reformatted content is delivered to the device over the global communications network. Also disclosed is a method and system for formatting data requested from an application program interface via an application to enable processing of the data in the application to account for data retrieval speed restrictions, memory restrictions and processing capabilities, and/or necessary format translations (including schema remapping).

This application claims priority to U.S. Provisional Patent Application No. 60/266,969 filed Feb. 6, 2001.

### FIELD OF THE INVENTION

This invention relates to the authoring of content for the display of data across a full set of devices, wired and wireless, capable of displaying such information. This includes, by way of example and not limitation, personal computers, personal digital assistants, cell phones, and pagers. This invention also relates to reformatting data requested by an application of an application program interface.

### BACKGROUND OF THE INVENTION

The earliest need for the invention was evident from the birth of the Internet World Wide Web. Despite the standardization of HTML by the World Wide Web Consortium (W3C), different web browsers displayed web content differently. Today, with the proliferation of personal computing and communication devices like Web phones and Personal Digital Assistants (PDAs), each of which has a different user display, different content standards and browsers abound. In this world of diverging technologies, a system that will provide consistent presentation among all of these is highly desirable.

In the current Internet space, content is very tightly coupled with the devices that must display it. That is, the content sent from an information source to users for display must be formatted along the way for display on the particular user device. Content must be authored in a data format designed for the targeted device and presentation must be customized for this device. The present invention provides a robust, scalable, and maintainable design for a system that presents content in a uniform manner across all devices.

Many parties have created systems that have tried to solve the problem of providing consistent multi-device visual display presentation. Most of the solutions follow the design that is presented in FIG. 1. A client 40A (which may be a user device or a server) generates a request for information from the network (e.g., the Internet). The prior art formatting solutions typically include a set of adapters 10 that convert the raw information into a proprietary format, commonly a form of Extensible Markup Language (XML). These systems often obtain their data from multiple sources and in different formats. The number of adapters 10 required generally scales linearly with the number of data sources originating content for processing and, ultimately, display.

The crux point in the process is an object model language 20 for describing a generic user interface, shown in FIG. 1 as XML. Next in the process are software components, referred to here as transformers 30. The transformers 30 function by taking the information that is in the proprietary data format (here, XML) and converting it to the markup language (ML) appropriate for the client 40A with which the system is communicating. For example, if the system is talking to a client 40A that is a wireless phone operating with a Wireless Markup Language (WML) 32 display (which is most common), then the content for visual display on the user interface will be transformed into WML. Thus, the number of transformers 30 required will be equal to the number of ML's that the supported device set contains (that is, the number of different device types that the application supports). One of the greatest weaknesses of the prior art design is the large number of adapters and transformers needed to service all device types supported by an application, resulting in a need for a great deal of maintenance

### SUMMARY OF THE INVENTION

The present invention is directed to a system and method for formatting content for display on a device. One or more data sources of information objects comprising at least one computer language object, at least one browser object, and at least one device object are maintained. A request for information is received from a device over a global communications network. A device type is identified, the device type comprising a communication format, a browser type, and a hardware type. The content is retrieved in response to the request and is formatted in a standard markup language, regardless of the identified device type. One of the computer language objects for the identified communication format, one of the browser objects for the identified browser type, and one of the device objects for the identified hardware type are retrieved from at least one of the data sources. Based on the retrieved computer language object, browser object and device object, the content is reformatted into a language that enables display of the content on the device. The reformatted content is delivered to the device over the global communications network.

The present invention is also directed to a method and system for formatting data requested from an application program interface via an application. One or more data sources of information objects, including at least one interface object, are maintained. A request for the data is received from the application over a global communications network and an interface is identified. The data is retrieved in response to the request, and formatted in a standard markup language, regardless of the identified interface. The interface object for the identified interface is retrieved from at least one of the data sources. Based on the retrieved interface object, the data is reformatted to enable processing of the data in the application to account for data retrieval speed restrictions, memory restrictions and processing capabilities, and/or necessary format translations (including schema remapping). The reformatted data is delivered to the application over the global communications network.

### BRIEF DESCRIPTION OF THE DRAWINGS

FIG. 1 is an example of the design of prior art systems.

FIG. 2A is a functional block diagram of one preferred embodiment the present invention.

FIG. 2B illustrates an alternative embodiment of the user device illustrated in FIG. 2A.

FIG. 3 is a block diagram of a exemplary transformer hierarchy according to one embodiment of the present invention.

FIG. 4 is a diagram of an exemplary algorithmic process of the invention.

FIG. 5 is a flow diagram illustrating a method of formatting content for display on a device in accordance with a preferred embodiment of the present invention.

FIG. 6A is a functional block diagram of another preferred embodiment of the present invention.

FIG. 6B is a block diagram of an exemplary interface object according to one embodiment of the present invention.

FIG. 7 is a flow diagram illustrating a method of formatting data requested from an application program interface via an application in accordance with a preferred embodiment of the present invention.

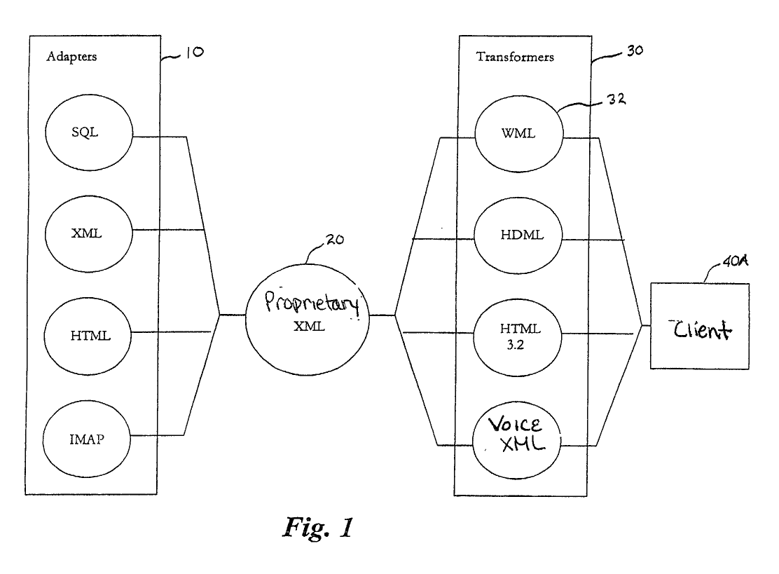

### DETAILED DESCRIPTION OF THE INVENTION

The present invention is directed to a process for acquiring information from an electronic network source and operating on that information such that the information may be sent to a user device and be displayed to the user in a predetermined format, regardless of the device type and user interface. The invention comprises a rendering engine that identifies the device type that requested information from a source over a network. Upon receipt of the information from the information source, the rendering engine performs a transform on the data that is based upon an object-oriented hierarchy of formatting languages, browsers, and device types. The inheritance feature of the object-oriented hierarchy allows the rendering engine to be updated to accommodate new browsers and device types without changing any of the existing transformation logic of the engine, thus avoiding the introduction of functional problems when new devices and browsers appear in the data communications market. The process of the invention adopts a standard information markup language format (XHTML in one preferred embodiment) for which the transformation process is adapted. The process allows all information sources to standardize their data delivery in the chosen markup language so that the information display on a user's device can be standardized no matter what device is used to request and receive information from the source.

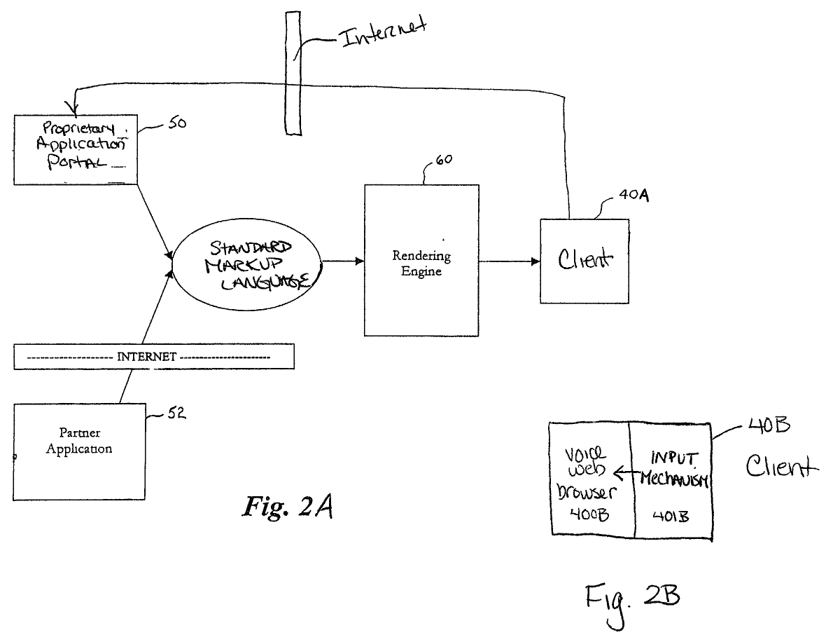

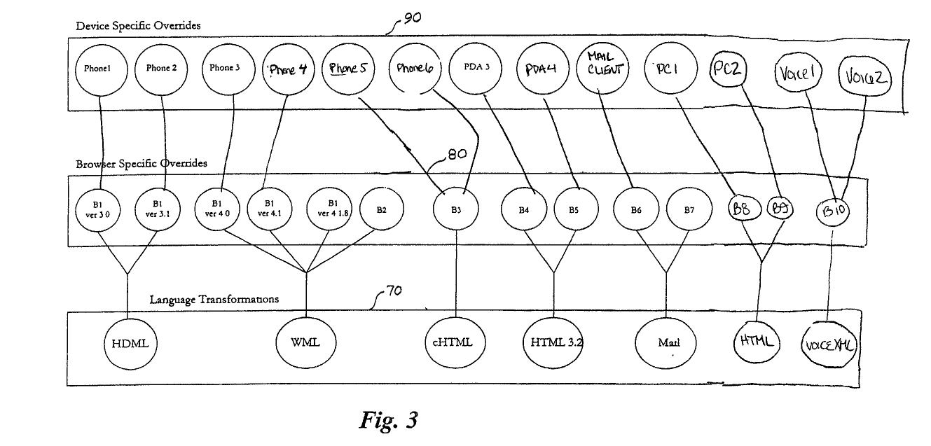

Referring to FIG. 2A, information content may be displayed on a client 40A in a predictable and uniform format regardless of the type of user device that requests the information. The process comprises a request for information from a client 40A that is passed to a source information provider, which may be a proprietary application 50 or an independent application 52. The request causes information to be accessed and transmitted by the application 50, 52 electronically in a standard markup language format, shown as XHTML in FIG. 2A. Other standard languages may be employed.

On its journey back to the client 40A, the information encounters a rendering engine 60. The rendering engine 60 performs an object-oriented transformation process that uses the standard language pre-formatted information as its input. The rendering engine 60 operates on the pre-formatted information by passing it through a format transformation process designed to reformat the information into a display format compatible with the particular client 40A that requested the information.

In one exemplary embodiment, a proprietary content provider, operates an Internet portal in which the proprietary application 50 of FIG. 2A resides. The proprietary content provider may form associations with other individual content providers that operate their own information sources available over the Internet. Each of these associated content providers operate an independent application 52 shown in FIG. 2A. The independent application 52 may be accessed through the Internet as well, as shown. The present invention makes it possible for each content provider to be assured that information that it intends to be displayed on a client 40A in a designed format will actually appear that way on a user device, regardless of the device and the browser operating the interface on the device.

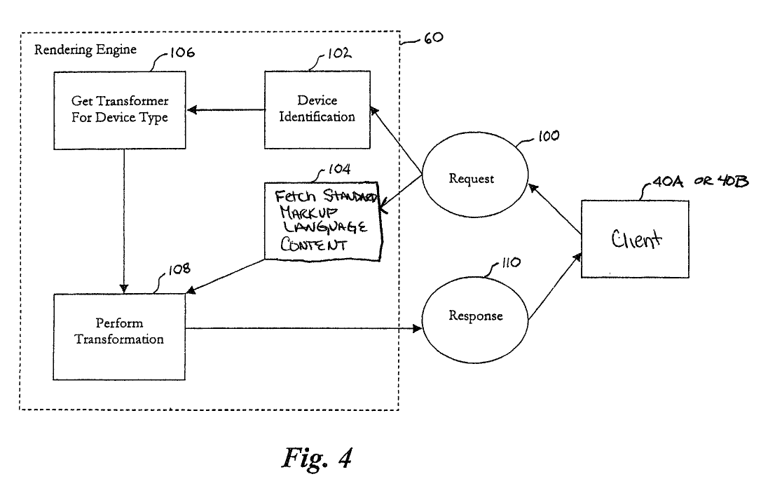

Referring to FIG. 3, an example illustrating the structure of the information transformation process of the rendering engine 60 is shown. The transformation process is based on an object-oriented hierarchy of information format languages, browser types and versions, and device types. The hierarchy comprises, first, a set of transform language objects 70, such as hand-held device markup language (HDML), wireless markup language (WML), hypertext markup language (HTML), compact HTML (cHTML), voice HTML and so on, as shown. The hierarchy further comprises browser-specific overrides 80 mapped to the transform languages that the browsers are designed to accept. In FIG. 3, the browsers are characterized as B1, B2, . . . B10, representing various browsers, including voice browsers, that may be installed in, for example, wireless phones, personal computers, and personal data assistants in the market. FIG. 3 also shows browser type B1 in several versions, which is a common reality. Finally, a set of device-specific overrides 90 complete the transformation object hierarchy. In FIG. 3, the devices illustrated are wireless phones (Phone1, Phone2, . . . Phone6), personal data assistants such as pocket computers (PDA's), PCS devices and so on, as shown. The transformation objects 70, browsers, and devices described and illustrated are exemplary; the invention is equally applicable to other types of transformation objects, browsers and devices.

This transformation hierarchy takes advantage of the inheritance feature of object-oriented design; namely, each layer in the hierarchy inherits functionality from a component in a layer beneath it. Thus, a transform from the standard language into one of the display languages can be customized easily by applying an override function for the specific browser and device through which the formatted information will be displayed to the user. By way of example, assume a device has requested information from the proprietary portal application 50 (FIG. 2A) on the Internet. The rendering engine identifies the device type and browser that generated the request from codes embedded, such as header fields, in the request. Once the information is retrieved from the proprietary application in the standard format language (e.g., XHTML basic), the information encounters the transform process in rendering engine 60. At this point, the standard format will be transformed into the format required to cause the information to be displayed correctly on the client 40A.

In a specific example, the rendering engine 60 looks up the device type and determines that the device is Phone 4, operates using a WML communication format, and that the device's browser is B1 ver. 4.1 in the object hierarchy. The WML transform object is selected to operate on the standard language formatted information. The WML object is modified with overrides from the B1 ver. 4.1 and Phone 4 overrides in the object hierarchy. The transform is then accomplished, creating a WML output format adapted for Phone 4 using browser B1 ver. 4.1 for display. The information display format is then completely compatible with the display device and browser.

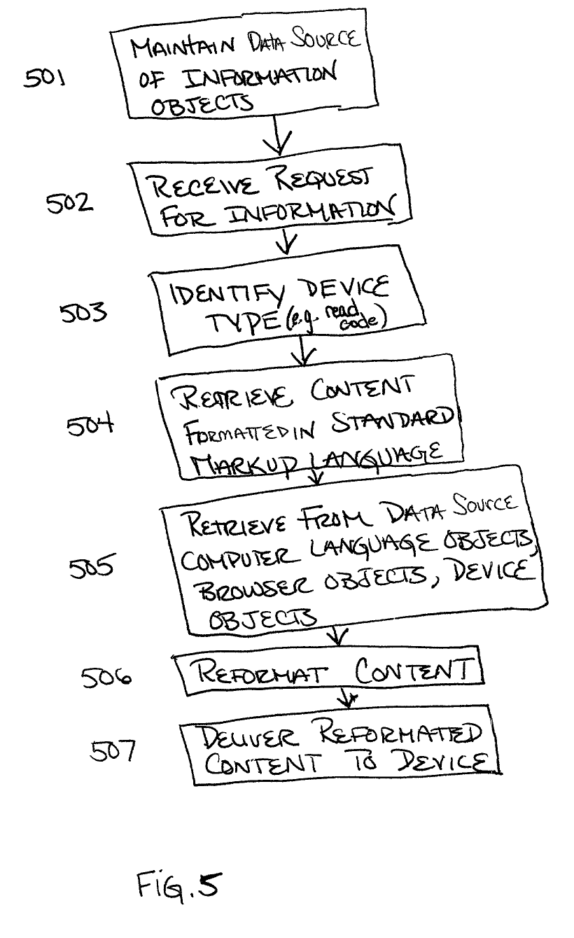

Referring to FIG. 4, there is shown an exemplary functional algorithm that operates the process of a preferred embodiment of the present invention. The client 40A originates a request 100 for information over the network. The request 100 is received at the rendering engine 60. The rendering engine 60 identifies, in step 102, the device that originated the request by reading a code embedded in the request. The rendering engine 60 fetches, in step 104, the content requested by the user message. The content is formatted in the standard language. The fetch may acquire the content from the proprietary application or from an independent content provider that also formats its information in the selected standard markup language format, shown here as XHTML. In some embodiments, the independent content provider maintains several forms of content applicable to different classes of devices. For example, the independent content provider may maintain and return content that is appropriate for small, medium or large devices (such as, for example, mobile and non-mobile phones, PDAs and personal computers, respectively), depending on the type of device that requested the content.

While the content is being acquired, in step 106, the transformer object for the client 40A that sent the information request is obtained. As shown in FIG. 3, the transformer object is customized for the particular device and browser that will display the information to the user. In step 108, the transformation on the standard format information is performed, converting it into a format language compatible with the user device. This formatted information becomes the response that is delivered to the user device in step 110. In one embodiment, the response delivered to the user is conversational, for example, where the device employed by the user is a telephone. FIG. 2B illustrates an alternative embodiment, client 40B, of client 40A shown in FIG. 2A that enables the response delivered to the user to be conversational. In particular, the user employs the input mechanism 401B (i.e., a key pad or a voice receiver) on his telephone (i.e. client 40B) that connects to web browser 400B in order to input information. The conversational response delivered back to the user is transmitted via web browser 400B.

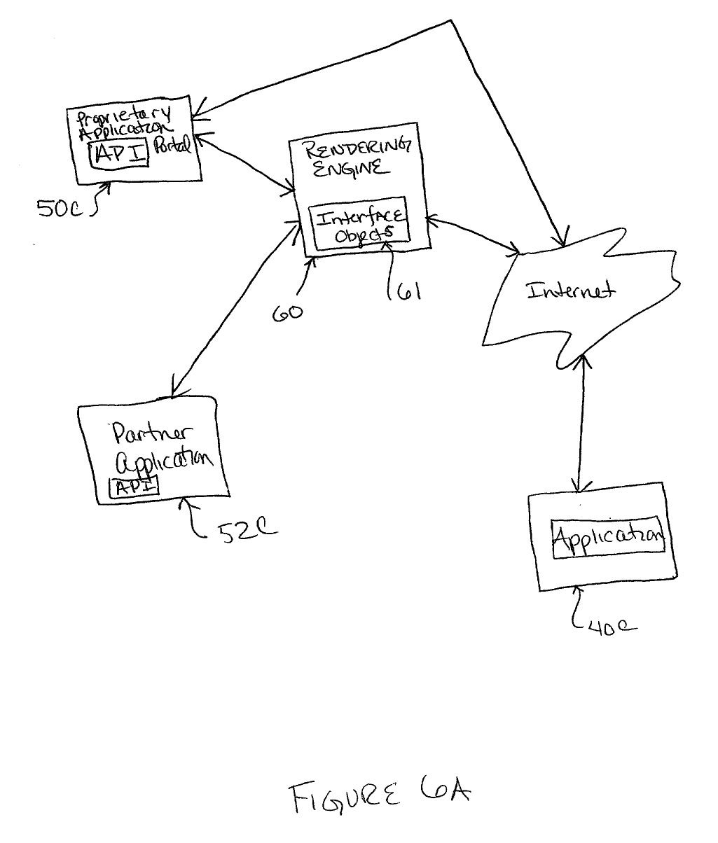

With reference to FIG. 5, a flow diagram illustrating a method of formatting content for display on a device in accordance with a preferred embodiment of the present invention is shown. One or more data sources, such as databases, of information objects comprising at least one computer language object, at least one browser object, and at least one device object are maintained in step 501. A request for information is received, in step 502, from a device over a global communications network. In step 503, a device type is identified, the device type comprising a communication format, a browser type, and a hardware type. The content is retrieved, in step 504, in response to the request, formatted in a standard markup language regardless of the identified device type. One of the computer language objects for the identified communication format, one of the browser objects for the identified browser type, and one of the device objects for the identified hardware type are retrieved from at least one of the data sources, in step 505. Based on the retrieved computer language object, browser object and device object, the content is reformatted into a language that enables display of the content on the device, in step 506. The reformatted content is delivered to the device over the global communications network, in step 507.

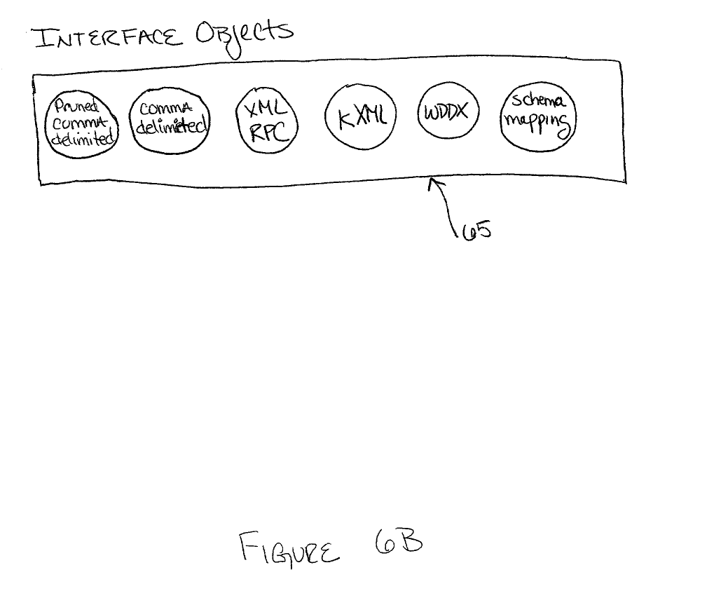

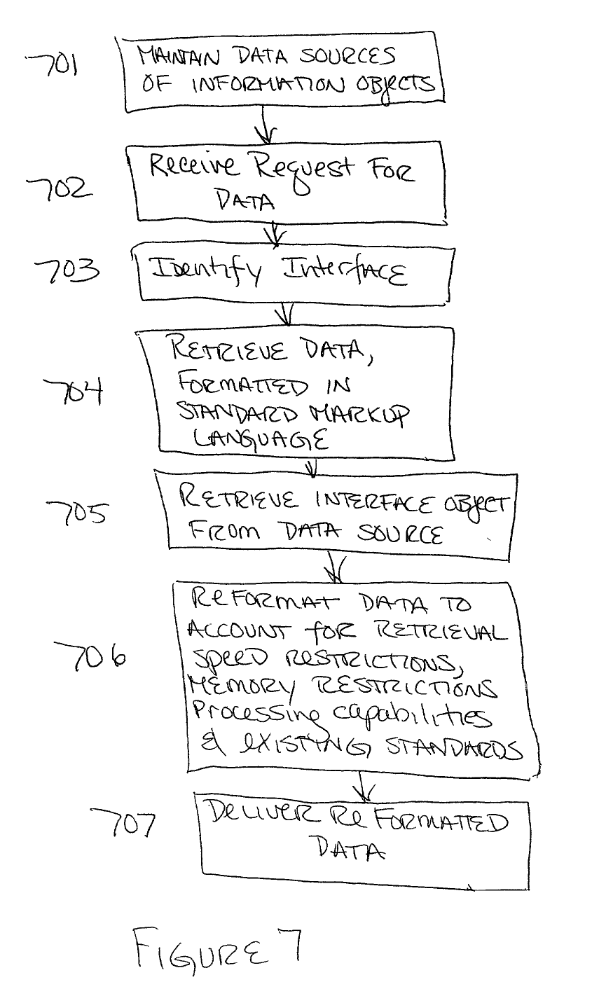

In one embodiment of the present invention, data is requested by an application. The application may be operating on a client, including a device or a server, by way of example. The request is made to an application program interface (“API”) to retrieve data for use with the application. In this embodiment, the data returned to the application is reformatted to enable processing of the data to account for data retrieval speeds, memory and processing capabilities, and/or necessary format translations (including schema remapping). One example of this embodiment is illustrated with reference to FIG. 6A. An application operating on client 40C (which may be, for example, a device or a server) requests data, via the Internet, from an API, on client 50C or client 52C (which, again, may be a device or a server). An interface for the application identified. The data is retrieved and transmitted electronically in a standard markup language format. The data then encounters rendering engine 60. Rendering engine 60 maintains one or more data sources that include at least one interface object 61. The interface objected for the identified interface is retrieved. Based on the retrieved interface object, rendering engine 60 reformats the data to account for data retrieval speed restrictions, memory restrictions and processing capabilities, and/or necessary format translations (including schema remapping). The reformatted data is then returned to the application. FIG. 6B illustrates an exemplary interface object 65. Some exemplary interfaces that may be used in accordance with a preferred embodiment of the present invention include, as shown, pruned comma delimited, comma delimited, XML RPC (XML remote procedure call), kXML, WDDX, and schema mapping. Other interfaces may be used in accordance with the present invention and will be known to those skilled in the art.

With reference to FIG. 7, a method for formatting data requested from an application program interface via an application is illustrated. One or more data sources of information objects, including at least one interface object, are maintained in step 701. A request for the data is received from the application over a global communications network, in step 702, and an interface is identified, in step 703. The data is retrieved in response to the request, in step 704, formatted in a standard markup language, regardless of the identified interface. The interface object for the identified interface is retrieved from at least one of the data sources, in step 705. Based on the retrieved interface object, the data is reformatted to enable processing of the data in the application to account for data retrieval speed restrictions, memory restrictions and processing capabilities, and/or necessary format translations (including schema remapping), in step 706. The reformatted data is delivered to the application over the global communications network, in step 707.

The foregoing description of the preferred embodiments is provided to enable those skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A method of formatting content for display on a device comprising:
maintaining one or more data sources of information objects comprising at least one computer language object, at least one browser object, and at least one device object;
receiving from the device a request for information over a global communications network;
identifying a device type, the device type comprising a communication format, a browser type, and a hardware type;
retrieving the content in response to the request, wherein the retrieved content is formatted in a standard markup language regardless of the identified device type;
retrieving from at least one of the data sources one of the computer language objects for the identified communication format, one of the browser objects for the identified browser type, and one of the device objects for the identified hardware type;
based on the retrieved computer language object, browser object and device object, reformatting the content into a language that enables display of the content on the device; and
delivering the reformatted content to the device over the global communications network.

2. The method of claim 1 wherein identifying the device type comprises:
reading one or more codes embedded in the request.

3. The method of claim 2 wherein the one or more codes comprise one or more header fields.

4. The method of claim 1 wherein at least one of the browser objects comprises a browser version object.

5. The method of claim 1 wherein the standard markup language comprises at least one of XHTML and XHTML Basic.

6. The method of claim 1 wherein the communication format comprises at least one of HDML, WML, HTML, cHTML and voiceXML.

7. The method of claim 1 wherein the browser type comprises at least one of a wireless phone browser, a personal computer browser, a voice browser and a personal data assistant browser.

8. The method of claim 1 wherein the hardware type comprises at least one of a personal computer, a wireless telephone, a telephone voice interface and a personal data assistant.

9. The method of claim 1 wherein the at least one computer language object, browser object and device object are arranged in a hierarchy of objects, said hierarchy of objects comprising at least three layers, and wherein each said object in a first layer of said hierarchy inherits functionality from each said object in a second layer of said hierarchy below said first layer.

10. A method of formatting data requested from an application program interface via an application comprising:
maintaining one or more data sources of information objects comprising at least one interface object;
receiving from the application a request for the data over a global communications network;
identifying an interface;
retrieving the data in response to the request, wherein the retrieved data is formatted in a standard markup language regardless of the identified interface;
retrieving from at least one of the data sources the interface object for the identified interface;
based on the retrieved interface object, reformatting the data to enable processing of the data in the application to account for data retrieval speed restrictions, memory restrictions and processing capabilities; and
delivering the reformatted data to the application over the global communications network.

11. The method of claim 10 wherein the data is further reformatted to enable processing of the data in the application to account for format translations.

12. The method of claim 11 wherein the format translations comprise schema remapping.

13. The method of claim 10 wherein the application is operating on a client.

14. The method of claim 13 wherein the client is a user device.

15. The method of claim 13 wherein the client is a server.

16. A system for formatting content for display on a device comprising:
one or more data sources of information objects comprising at least one computer language object, at least one browser object, and at least one device object; and
one or more servers that receive a request for information from the device over a global communications network; identify a device type, the device type comprising a communication format, a browser type, and a hardware type; retrieve the content in response to the request, wherein the retrieved content is formatted in a standard markup language regardless of the identified device type; retrieve from at least one of the data sources one of the computer language objects for the identified communication format, one of the browser objects for the identified browser type, and one of the device objects for the identified hardware type; based on the retrieved computer language object, browser object and device object, reformat the content into a language that enables display of the content on the device; and deliver the reformatted content to the device over the global communications network.

17. The system of claim 16 wherein the at least one computer language object, browser object and device object are arranged in a hierarchy of objects, said hierarchy of objects comprising at least three layers, and wherein each said object in a first layer of said hierarchy inherits functionality from each said object in a second layer of said hierarchy below said first layer.

18. A system for formatting data requested from an application program interface via an application comprising:
one or more data sources of information objects comprising at least one interface object;
one or more clients that receive from the application a request for the data over a global communications network; identify an interface; retrieve the data in response to the request, wherein the retrieved data is formatted in a standard markup language regardless of the identified interface; retrieve from at least one of the data sources the interface object for the identified interface; based on the retrieved interface object, reformat the data to enable processing of the data in the application to account for data retrieval speed restrictions, memory restrictions and processing capabilities; and deliver the reformatted data to the application over the global communications network.

19. The system of claim 18 wherein the application is operating on a client.

20. The system of claim 19 wherein the client is a user device.

21. The system of claim 19 wherein the client is a server.

22. The method of claim 18 wherein the data is further reformatted to enable processing of the data in the application to account for format translations.

23. The method of claim 22 wherein the format translations comprise schema remapping.
